(19) United States
(12) Patent Application Publication
(10) Pub. No.: US 2003/0078975 A1
(43) Pub. Date: Apr. 24, 2003

(54) File based workflow system and methods

(76) Inventor: Norman Ken Ouchi, San Jose, CA (US)

Correspondence Address: NORMAN KEN OUCHI, 20248 VIEW CREST CT, SAN JOSE, CA, 95120, US

(21) Appl. No.: 09/974,594

(22) Filed: Oct. 9, 2001

(51) Int. Cl. G06F 15/16

(52) U.S. Cl. 709/205; 709/106

(57) ABSTRACT

This invention is related to workflow systems to support the control and execution of business processes and in particular business processes where the information is in the form of files. In the present invention, a business process is divided into steps where each step is executed by a person or program. A route is a representation of the sequence of steps in the process. The route can be used in a workflow system to control the execution of each step and track the progress of the route and hence the progress of the business process. Workflow systems have been applied to business processes where the information to be processed can be read on or entered into a computer screen. The present invention supports business processes where the information is in the form of computer files and the process steps are executed by users or programs that use files delivered by the workflow as input and produce files as output that are to be used in subsequent steps and deposited through the workflow screens for use in these subsequent steps. The invention provides for computer screens that direct specific files to be delivered and request specific files for deposit and provides for organization of the files to support the process implemented by the route.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

This invention is related to workflow systems to support the control and execution of business processes and in particular business processes where the information is in the form of files.

### BRIEF SUMMARY OF THE INVENTION

In the present invention, a business process is divided into steps where each step is executed by a person or program. A route is a representation of the sequence of steps in the process. The route can be used in a workflow system to control the execution of each step and track the progress of the route and hence the progress of the business process. Workflow systems have been applied to business processes where the information to be processed can be read on or entered into a computer screen. The present invention supports business processes where the information is in the form of computer files and the process steps are executed by users or programs that use files delivered by the workflow as input and produce files as output that are to be used in subsequent steps and deposited through the workflow screens for use in these subsequent steps. The invention provides for computer screens that direct specific files to be delivered and request specific files for deposit and provides for organization of the files to support the process implemented by the route.

### BACKGROUND OF THE INVENTION

Workflow concepts and tools permit the planning, controlling, and tracking of the step-by-step execution of a process. Workflow was originally applied to document processing where the processes were well defined and static. Insurance claims processing and loan application processing are examples of processes where workflow has been used in the past. In parallel, workflow technology has been applied to the manufacturing shop floor where the controlling and tracking of manufactured items in a manufacturing line are similar to the controlling and tracking of documents in an insurance claim process. Workflow technology has evolved so that it can be applied to most processes that have process steps that are executed by people or computer controlled equipment. A workflow can be used to implement a process by defining the steps in the process and the sequence of steps. The sequence of steps is called a route. A route can define a process with conditional branching to implement business processes such as an “Approve/Reject” process step or an iterative process that may require loops similar to Do While or For Loop of many programming languages. A route can implement parallel sub-routes including the splitting or “forking” of a route into parallel sub-routes and joining of parallel sub-routes. The fork and join steps may have conditional functions. Parallel computing has a very rich base of knowledge from which the construction of parallel workflow routes may draw. The route structure supports all the basic elements of a Turing machine so the Computer Science of computability may be applied to workflow. The workflow route is similar to a computer program and the workflow engine is similar to a computing engine that executes routes as programs. The key to workflow is the development of the route. Workflow definition can be developed using graphical tools and process modeling tools. Workflow not only is used for the definition of a process but also for the execution and tracking of the process. When a step in a route is completed, the workflow engine determines from the route the next step and sends the work to the person or machine responsible to complete the step. FIG. 1A illustrates a three-step route for a travel expense approval process where the traveler creates the travel expense request in Step 1, the manager approves or rejects the request in Step 2, and if approved, the travel expense request moves to Accounts Payable for payment to the traveler in Step 3. If the expense request is rejected, it is returned to the traveler at Step 1. Since the workflow is executing in real time, each step can be timed and if a step does not complete within a preset time, an alert using e-mail, pager, phone, etc. can be sent to the appropriate people to fix the cause of the delay. In a manufacturing process, the assembly of a product is defined by the sequence of steps and work centers where the steps are performed so that a set of parts and feedstock are transformed into the finished product. The route and workflow system define the sequence of steps and the people (work centers) to transform input information into finished information. In essence, the route and workflow system define an information assembly line.

However, the workflow systems are designed for information that can be displayed as screen images with input fields in the screens. For an important set of business processes such as the design and manufacture of a product, the information is in the form of computer data files. These files are typically very large, measured in megabytes, and not suitable for display on a screen. In fact the files are the output of specialized computer programs and are used as input to computer programs. Examples are the files generated by Computer Aided Design (CAD) Systems such as Pro-E provided by Parametric Technology Corp for designing mechanical assemblies or OrCAD provided by Cadence Systems for the design of electronic circuit cards. Files may contain the parts list, the Bill of Material (BoM) of a product or the cross reference of internal part identifiers to the identifiers used by the part suppliers called the Approved Manufacturer List (AML). The design, manufacture, and support of products usually require a number of files from programs and systems like these. The files are not only used in the originating system but are used in subsequent processes using these same programs or other programs. The information assembly line requires information in the form of files to be processed. So at a step a specific file must be made available for input to a process, usually a program. The output of the process is usually a file, which is then taken and passed to a subsequent step. In the prior art, these files are passed using diskettes sent by mail, sent as e-mail attachments, sent on the Internet using the File Transfer Protocol, FTP. There is no means to control the sending and receipt of files or to track the process. Files are lost, wrong files are sent, files are mislabeled, etc.

In addition, these business processes do not just use one file but rather a set of related files. The development of a product requires the creation and processing of a number of files: CAD, BoM, AML, Assembly instructions, test programs, etc. Thus, a product will have a set of files that describe it at a point in time. Most companies identify their products by associating an item identifier, a part number, to the product. The product may have changes during the development and production life so most companies also assign a revision designator or engineering change number or level to each version of the product. The files in the collection of files that describe the product at a specific engineering change level are labeled with the part number of the product and the engineering change level. A second relationship is the parent-child organization of some of the files. The product may be assembled from a set of sub-products or sub-assemblies. The description of the product may not have the detailed description of each sub-assembly but rather refer to the associated part number and engineering change level. The file that describes the product is the parent and the description of each of the sub-assemblies is a child to the parent. This relationship is illustrated in FIG. 1B where File 1 Parent is the parent to File 2 Child as a child and File 3 Child as another child. However, unlike biological children who can be a child to only one set of biological parents, a file can be a child to more than one parent file. A sub-assembly may be used in many different products. A third relationship is due to changes made to the product. For example, a CAD file may describe a product under development. The contents of the file changes as the description of the product is refined and tuned to meet the product specifications. The changes are frequent and do not warrant assigning an engineering change level. During the development phase it is not uncommon to have several alternative designs, which may have been derived from a common base file. FIG. 1C illustrates a file derivation tree with File 1a as a base file. File 1b and File 1c are derived from File 1a. File 1d is derived from File 1c. A fourth relationship is due to the processing of files which produces output files. A CAD file is processed to create a test analysis file. It is desirable to keep the genealogy so that the input source files can be associated with the output files. The engineering change level is very useful to assure a consistent set of files that describe a product. However, during the development phase changes are rapid and often and it is not possible to assure a consistent set of files and assignment of an engineering change level. During this phase, it is desirable to keep the relationship of the files to trace the genealogy in case it is needed rather than use the formal engineering change process.

In addition, the files are assigned file names given by the users or the system that created the file. The file content may not be apparent in the file name. The Bill of Material may be in the form of a Microsoft Word document, an SAP flat file, or a Microsoft Excel spreadsheet. It is desirable to associate the classification of the file with the file in the file system so that subsequent steps can provide the correct file independent of the file name or file format.

The prior art provides programs and processes to keep and organize of files associated with a product. Document control is the term associated with these processes and product document management, PDM, systems to support these processes are focused on the engineering change processes. Matrix One, Agile, Parametric Technology and others provide PDM systems but are mostly used by document control specialists. These products suffer from two major deficiencies: 1) the processes are applicable when the engineering change control processes are used which is late in the product development process and 2) the processes and systems are focused on the document control specialists and the engineers in development, manufacturing and test do not use the system.

What is desired is a means to bring the power of the workflow technology for use in processes where the information is in the form of files. A second desire is that the user screens be easy to use so that engineers will use the system. A third desire is that the file relationships and classifications be maintained with a minimum of user intervention so that the processes and systems may be used during the entire development and manufacturing life of a product.

### BRIEF DESCRIPTION OF DRAWINGS

FIG. 1A illustrates a travel approval workflow.

FIG. 1B illustrates a parent-child relationship between files.

FIG. 1C illustrates a file derivation tree.

FIG. 2A illustrates a workflow without consideration to files

FIG. 2B illustrates a workflow that considers the processing of files.

FIG. 3A illustrates the workflow steps with file accept steps and file deliver steps.

FIG. 3B illustrates a business process with file processing.

FIG. 4A illustrates a Tailored Classified File Attachment Screen for attaching a classified file.

FIG. 4B illustrates a Tailored Classified File Attachment Screen for attaching classified files with a parent-child relationship.

FIG. 5A illustrates a Tailored Classified File Download Screen for downloading a classified file.

FIG. 5B illustrates a Tailored Classified File Download Screen for downloading classified files with a parent-child relationship.

FIG. 6A illustrates a business process with file processing

FIG. 6B illustrates the Process flow for the business process in FIG. 6A, the Workflow route, and associated Screens.

FIG. 7 illustrates the relationship of the workflow route steps, the associated screens, the attachment of files, the storage of files, the retrieval of a file, and the download of the file.

FIG. 8 illustrates the business process with file processing in FIG. 3B and the relationship of the route steps, the associated screens, the attachment and downloading of files using a file server with a classification database, and the processing of files by users to accomplish the business process with a file based workflow system.

FIG. 9A illustrates a screen that will download classified files with different iterations.

FIG. 9B illustrates a decision entry screen associated with a step that has a conditional branch.

FIG. 10 illustrates a block diagram of an implementation of a file based workflow system and users connected using the Internet with screens implemented as Web pages.

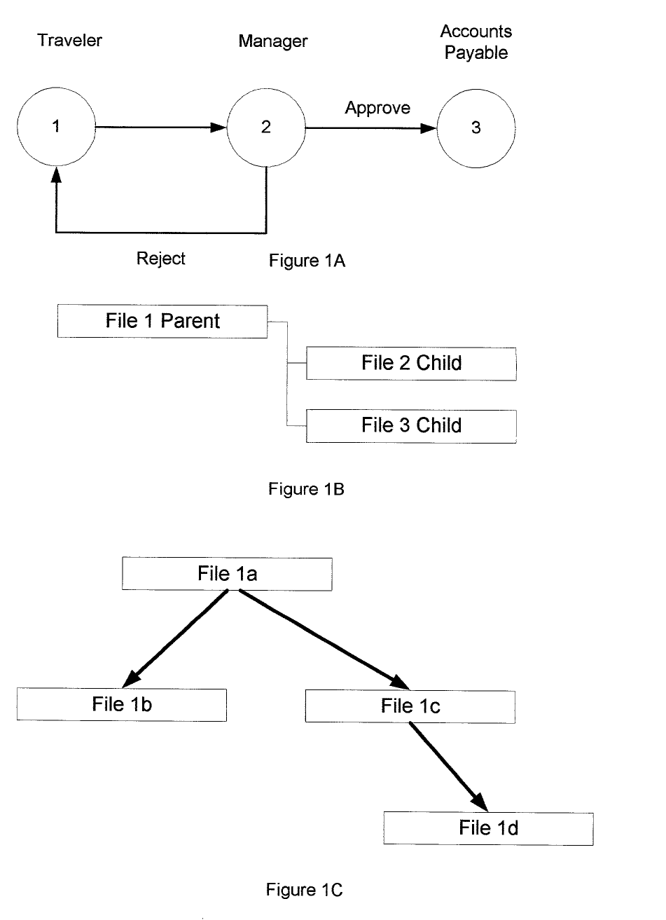

### DESCRIPTION OF THE INVENTION

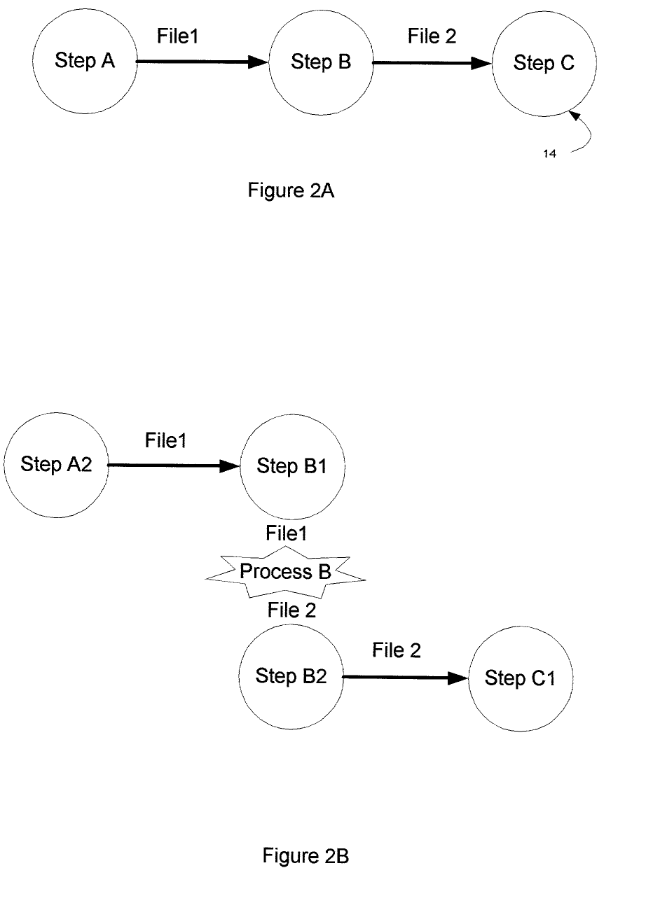

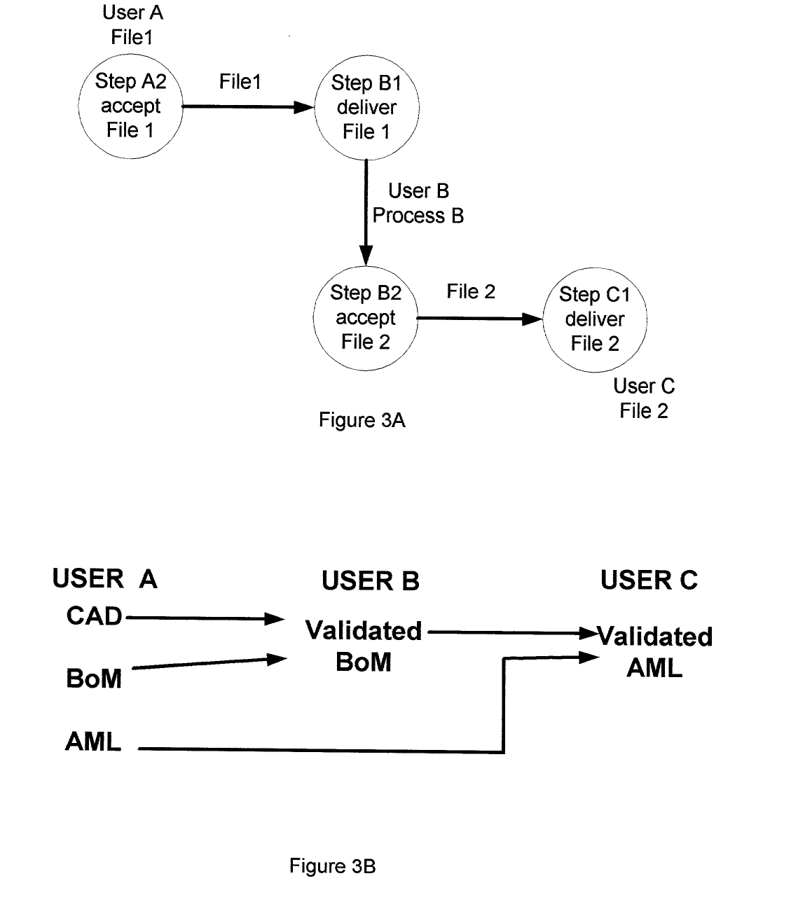

A business process is defined where User A creates a File land sends it to User B; User B uses the File 1 as input to Process B and creates File 2, and sends it to User C; User C uses File 2 as the final output for the process. The route for this three step process in the prior art would be represented in FIG. 2A as a three step route. But in reality, as illustrated in FIG. 2B, the process consists of User A creates File 1 and sends it to User B; User B receives File 1, runs Process B using File 1 as an input to create File 2, and sends File 2 to User C; User C uses File 2 as the final output for the process. User B performs three functions in Step 2 of FIG. 2A: receives File 1, runs Process B using File 1 to create File 2, and sends File 2 to User C. These functions are illustrated in FIG. 2B between Step B1 and Step B2. Step 2 in FIG. 2A must be split into the two steps, Step B1 and Step B2 in FIG. 2B. The workflow route illustrated in FIG. 3A has four steps to control and track these activities. Step A2 accepts File 1 from User A and sends it to User B. Step B1 delivers File 1 to User B. User B runs Process B to create File 2. Step B2 accepts File 2 from User B and sends it to User C. Step C1 delivers File 2 to User C. There are two types of user screens: 1) a screen to accept a file and 2) a screen to deliver a file. The function to accept a file permits the user to identify a file that is stored on a device accessible by the user on a local or wide area network and move it over the network and associate the file with the route step. These are the functions performed when “attaching” a file to an e-mail note in an e-mail system. Most Internet web browsers such as Microsoft Internet Explorer and Netscape Navigator provide this capability as a built-in function that may be used as part of a Web page. The complementary function used to deliver the file permits the file to be moved to a storage device attached to the local or wide area network. This function is performed when “downloading” a file attached to an e-mail. Most Internet browsers support this function that can be used as part of Web page function. The e-mail attachment and download functions permit a user to attach one or more files to an e-mail and send the e-mail to a recipient. The recipient receives the e-mail and the files that were sent can be downloaded and stored or processed by the recipient. The present invention provides the means by which business processes that require files for processing may be implemented with workflow technology. An example of a business process is illustrated in FIG. 3B where User A obtains the CAD file, BoM file, and AML file for a product. User B uses the CAD file and the BoM file as input to create the file called a Validated BoM file. User C uses the Validated BoM file and the AML file as input to create the file called the Validated AML file. E-mail attachments could be used for the file transfer process but this would require coordination among the users and each execution of the process would require this level of coordination. The functions of the present invention will be described and configured to implement business processes.

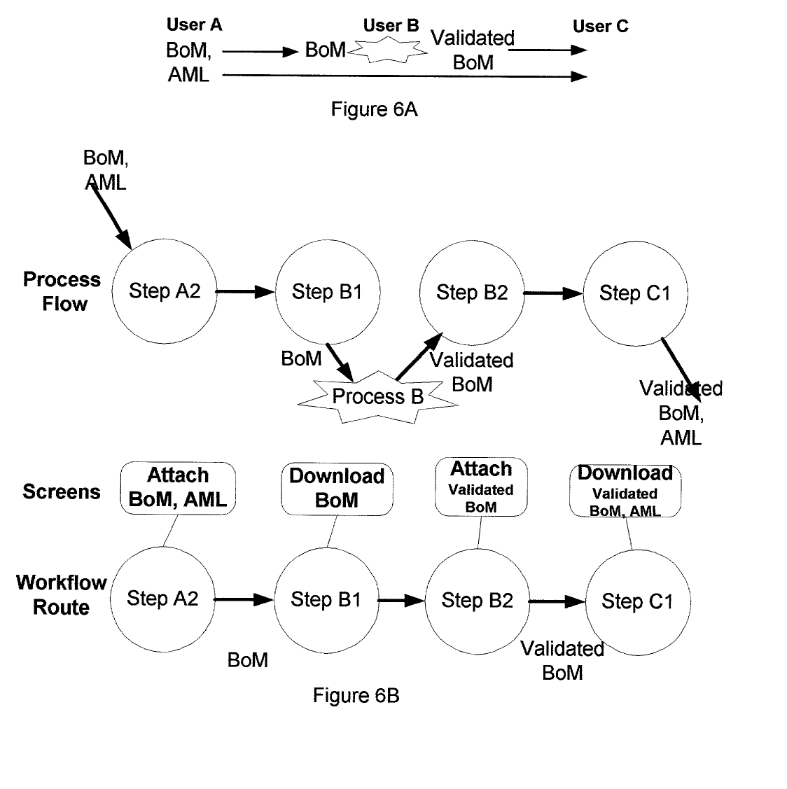

The business process defines the kind of files, or classification, needed to produce the output file. In the example are five file classifications: CAD, BoM, AML, Validated BoM, and Validated AML. A file classification is a meta-name used to relate a file created at one step to its use at another step and for general reference in the file system with respect to the type of information in the file. For example a BoM file is attached in Step A2 and downloaded in Step B1 in FIG. 6B. The actual file name will be determined at the time the file is attached but the route needs a means to relate its use in other screens thus, the meta-name “BoM” is used for this relationship. The meta-name is also used in the file system so that files that have information that serve the same function maybe accessed in a uniform manner. Thus, all BoM files for a part number may be found using the classification meta-name “BoM”. A file may actually be two or more files with a parent-child relationship. For example, the BoM may consist of a parent BoM file with one or more child BoM's for sub-assemblies. The attachment process and the download process must permit parent-child file structures. Some business processes may permit iteration or loops where the file contents may change with each iteration. The download must select the most recent iteration and the system must account for the iterations and other changes to files while in the process. The system must also maintain the relationship between the input files and the derived output file. In the example of FIG. 3B, the Validated BoM file is related to the CAD file and the BoM file such that if the process is executed with a CAD file and BoM file for a product with a part number and engineering change level to create a Validated BoM file and later executed with another CAD file and another BoM file for the same product and engineering change level, the resulting Validated BoM file will not be confused with the earlier created Validated BoM. The classification and file identification may be implemented using a relational database table. Table 1 is an example of a classification table in a classification database.

TABLE 1
File Classification Table

| | Engineering | | | | | |
|---|---|---|---|---|---|---|
| Part | change | Classification | | Given | File | |
| Number | level | Meta-name | Iteration | Name | Name | Parent |
| 6789 | 45678 | CAD | 1 | Board1.bdx | 23456 | |
| 6789 | 45678 | BoM | 1 | BoM.xls | 23457 | |
| 6789 | 45678 | BoM | 1 | BoM2.xls | 23458 | 23457 |
| 6789 | 45678 | BoM | 2 | BoM.xls | 23789 | |
| 6789 | 45678 | BoM | 2 | BoM2.xls | 23790 | 23789 |
| 6789 | 45678 | BoM | 3 | BoM.xls | 23939 | |
| 6789 | 45678 | BoM | 3 | BoM2.xls | 23940 | 23939 |

The table has the part number of the product; the engineering change level; the classification meta-name; the iteration; the given name, the name provided in the attachment screen; the internal file name that is used in the file system; and, the parent file in a parent-child relationship. In the example, all of the files belong to the same product part number and engineering change level. There is one CAD file that was used only once in a process so has an iteration number “1”. The file name in the attachment screen and displayed in the download screen is Board1.bdx. The internal file system uses the name “23456” to reference the CAD file. This file is not part of a parent-child relationship. There are six BoM files in three groups of two that are distinguished by their iteration number. The two BoM files with iteration “1” are one group and the two BoM files with iteration “2” are the second group and the two files with iteration “3” are the third group. Within each group is a parent-child relationship where the BoM file with a file name in the child field is a child of the BoM file with the file name. The BoM file, the first file with give name “BoM2.xls”, with “23457” in the child field is a child of the first BoM file “BoM.xls”. The second set of BoM files with iteration “2” have a similar relationship as does the third set of BoM files with iteration “3”. Note that the given names for the BoM files are the same in each set and the given name cannot be used to distinguish between files in different iterations. The internal file name permits these files to be distinguished and separate. Similarly, the output file of a process is assigned the same iteration number as the input files used to create the output file. Thus, the input and output file relationship can be established and maintained.

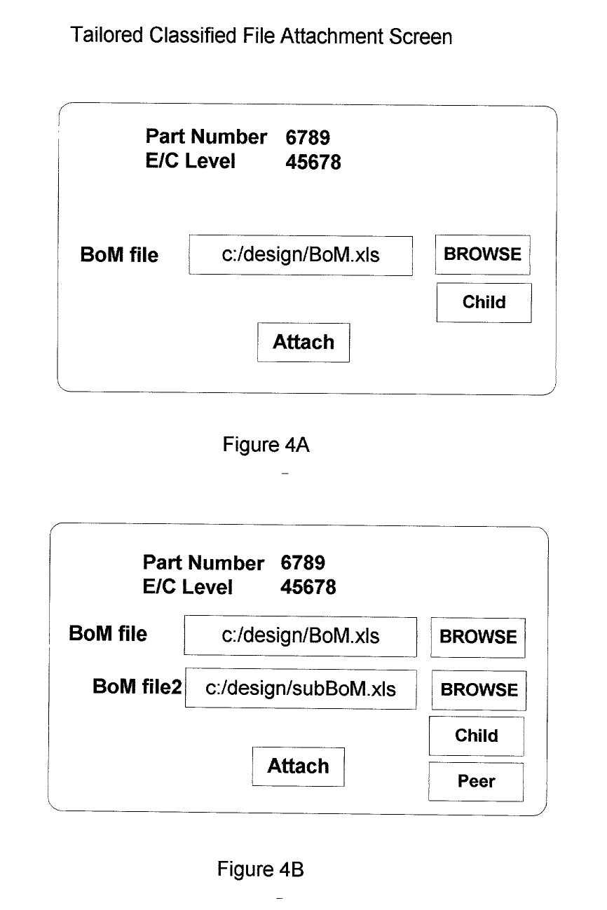

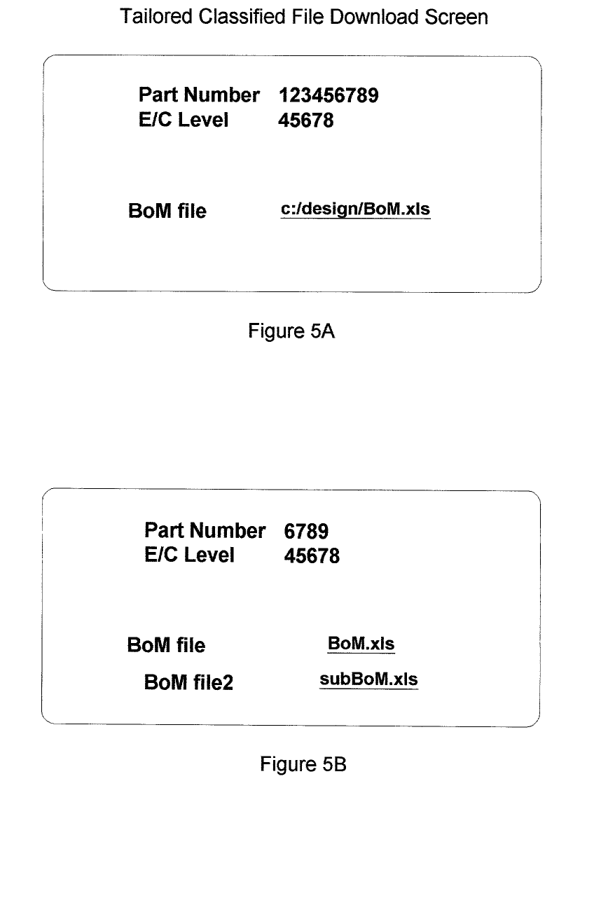

The bridge between the business process and the workflow system is the route, the sequence of steps in the process. Each step may present a screen for file attachment or for download. A file attachment screen presents a description of the product, usually the part number and engineering change level, and presents requests for files by classification meta-name to be attached. An attachment screen is illustrated in FIG. 4A where the BoM file for the product with part number 6789 and engineering change level 45678 is requested. A user receiving the screen will use the BROWSE button to locate the requested BoM file on a storage device local to the user or attached to the network accessible by the user. The ATTACH button moves the selected file from the storage device to the file system of the workflow system. In addition, the classification meta-name, in this case BoM, and the iteration of the process for this part number and engineering change level are associated with the transferred file and sent with the file. The iteration is used to distinguish files that may have the same file name and used for the genealogy of files and files derived from files, e.g. the Validated BoM file derived from a CAD file and a BoM file. The BoM may be a set of files with a parent-child relationship. In general, the need for a parent-child entry cannot be determined a priori so the attachment screen must have a mechanism so the user can transfer the files and communicate the parent-child relationship. The attachment screen illustrated in FIG. 4A has a CHILD button. Pushing the CHILD button exposes another browse window, BROWSE button, CHILD button, and PEER button as illustrated in FIG. 4B. The BoM meta-name is also repeated to indicate that a BoM child file is to be attached. The level of the child can be designated on the screen by a number or by indenting the designation. The user then locates the child file and attaches the file. If another child file is at the same level of the BoM, the PEER button is pushed and another set of browse window, designation, etc. appear. If a child file is to be attached to the first child file, the user pushes the CHILD button. Repeated application of these buttons and browse windows will permit the user to construct the parent-child tree structure of a BoM of arbitrary complexity. The download screen is illustrated in FIG. 5A where the part number, 6789, and engineering change level, 45678, identify the product and the designation, BoM, indicates the classification of the file. The user clicks on the underlined file name to open the browse and save window that is familiar to most e-mail users to download the file from the workflow file system to the user's designated storage device. FIG. 5B illustrates a two level BoM with a parent BoM file and a child BoM file. Both the attachment screen and the download screen should be easy for those with e-mail experience to learn and use.

The file attachment and file download screens are tailored to match the specific process step designated in the route. The identification information such as the part number and engineering change level and the file classification meta-name and the browse windows for attachment or the files for the download screens are tailored so the user is clearly directed as to what is to be done. In the preferred embodiment, the screen information and configuration are derived from the route instance and the step associated with the screen. The route not only defines the sequence of steps but also defines the structure and content of the screen to be displayed at each step. FIG. 6A illustrates a process where User A deposits a BoM file and an AML file. User B receives the BoM file and runs a process to create a Validated BoM file. The original AML file and the Validated BoM file are sent to User C. FIG. 6B illustrates the process flow and the four steps of the process. The four step workflow route to support the process flow is illustrated with the four screens, each associated with a route step. At Step A2, the file attachment screen requests the attachment of the BoM file and the AML file by displaying a browse box for the BoM and a browse box for the AML. The file attached in the BoM browse box is classified as a BoM file; the file attached in the AML browse box is classified as an AML file. The iteration number is also associated with these files. At Step B1, the file classified as the BoM file is presented as a download file. At Step B2, the screen requests the Validated BoM by displaying a browse box of a Validated BoM. The file attached in the browse box is classified as a Validated BoM file and assigned the iteration number of the BoM file and the AML file. At Step C1, the screen displays the file classified as the Validated BoM file and the file classified as the AML file for download. If any of the files were parent-child structured files, the files and the relationship would be retained as these pass through the process. When the route is instantiated, execution started, the part number and engineering change level are provided and Users A, B, and C identified. The route starts by providing the screen for Step A2 to User A. When User A completes the file attachments, the screen for Step B1 is provided to User B. After User B downloads the BoM file, the screen for Step B2 is provided to User B. When User B completes the file attachment, the screen for Step C1 is provided to User C. After User C downloads the files, the route instance is complete. If the route is used again for the same part number and engineering change level, the iteration number is incremented so the files for each instance are segregated.

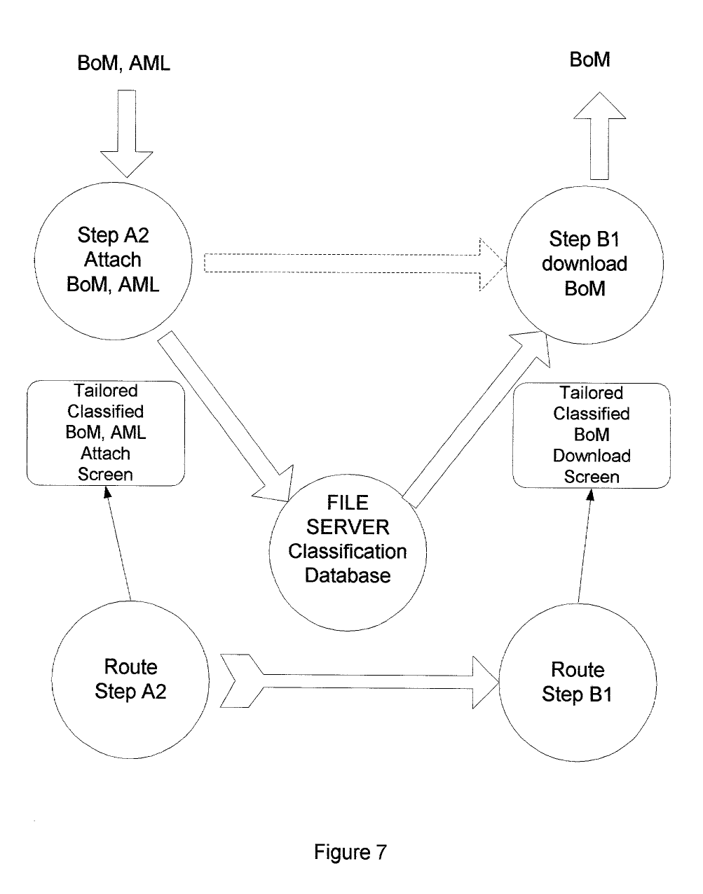

The route illustrated in FIG. 6B defines a sequence of steps where User A sends the BoM file to User B. The file is not sent directly from User A to User B but the files are sent from User A to a file server. The files are classified and stored in the file server. The BoM file for Step B1 is selected based on the route step from the file server and made available to B for download. This permits User A to attach a BoM file and an AML file at Step A2 and only the BoM file sent to User B at Step B1. FIG. 7 illustrates the steps of this function. Route step A2 provides the screen requesting the BoM file and AML file from User A. The BoM file and AML file are attached and transferred to the file server. In the file server, the files are classified as the BoM file and the AML file for a specific part number, engineering change level, and iteration instance of the route. The classification is kept in a database since there may be duplicate file names associated with different iterations, part numbers, or engineering changes. The route advances to Step B1, which provides the screen to User B to download the classified BoM file from the file server. Unlike attachments to an e-mail where what was attached is received, the classified file server can receive a set of files and send a different set of files. The route can fork into parallel sub-routes where two recipients receive different sets of files or parallel sub-routes join to accept different sets of files from uses at two different steps.

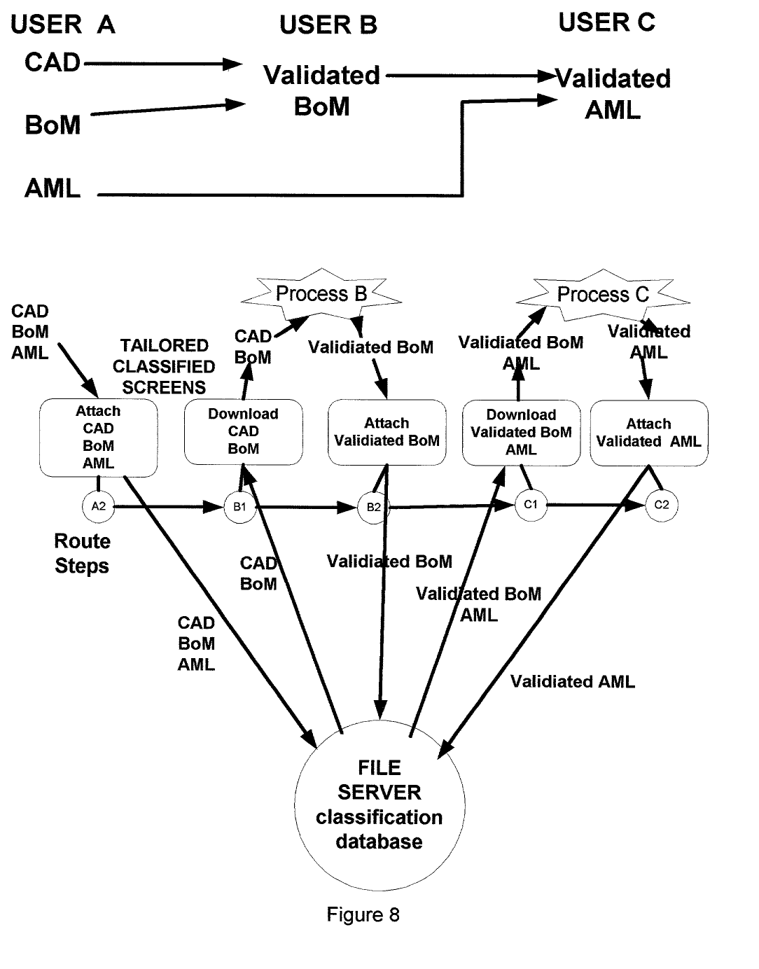

FIG. 8 illustrates the route to support the business process illustrated in FIG. 3B. The business process is illustrated again in the upper section of FIG. 8. The route starts with Step A2 with a screen that requests the CAD, BoM, AML files for a product part number and engineering change level from User A. User A attaches these files that are then classified and stored in the file server. The route advances to Step B1 with a screen that provides the classified CAD and BoM files for download. After User B downloads the CAD and BoM files from the file server, the route advances to Step B2 with a screen that requests the Validated BoM file from User B. When User B attaches the Validated BoM file, the file is classified and stored in the file server and the route advances to Step C1. Step C1 provides User C with a download of the Validated BoM and AML files. When User C downloads the Validated BoM and AML files from the file server, the route advances to Step C2 that requests the Validated AML. When User C attaches the Validated AML, the Validated AML is classified and stored in the file server. This completes the instance of the route. FIG. 8 illustrates the interrelated functions of elements of the present invention. The process is divided into steps where a part of the process is executed at each step and the sequence of steps comprising the entire process. Each step in the sequence is associated with a route step where the files used or files produced are determined. Each file type is classified with a meta-name, e.g. BoM, CAD, etc. A screen is associated with each route step where the screen can attach classified files or download classified files. A use of the process is initiated by starting an instance of the route by providing the description of the product: e.g. part number and engineering change level, and the user at each step in the route. The workflow system uses the route and the functions of workflow may be used to control and track the execution of the process. The workflow directs the screen for a specific step to the assigned user, tracks when the user received the screen and when the user completed the action requested by the screen, provides the current step and user for each active route instance, provides the step-by-step history of all pasted instances, provides each user a “To Do” list of all screens the workflow is expecting the user to execute, etc. The present invention augments the functions of a workflow system so the power of the workflow system can be applied to processes where the information to be processed is in the form of files.

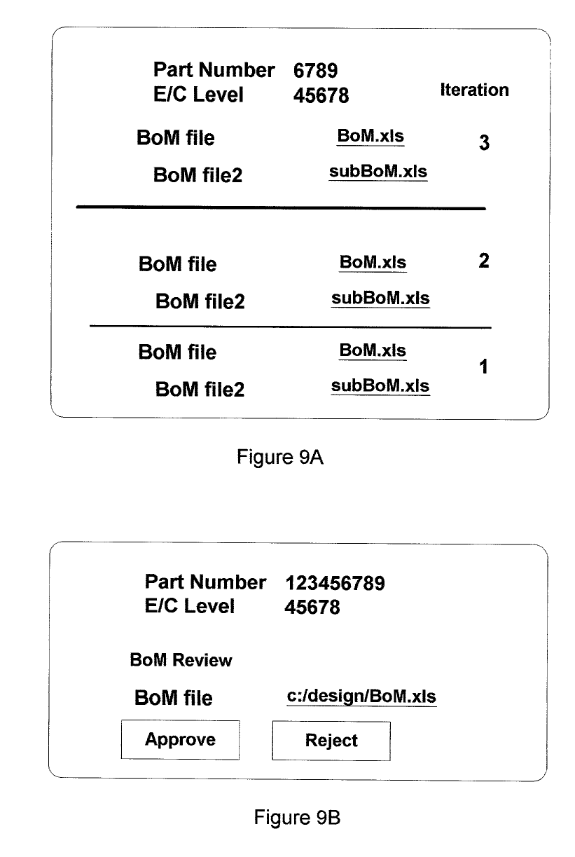

In addition to the workflow functionality, the system provides a structured file system where the file classification relates each file to its content and use. For example, the BoM for a product may be accessed by product part number and engineering change level. The BoM for the product independent of engineering change level may be accessed using only the part number. Files associated with an engineering change level may be accessed using only the engineering change level, etc. The iterations of file created in multiple uses of a process or in a loop in the process are also distinguishable and accessible. In general, the most recent iteration of a file is used in an instance of a process. However, all past versions may be saved and accessed. FIG. 9A illustrates the BoM files for part number 6789 at engineering change level 45678. In the illustration, the route is in the third iteration and the BoM files for the current iteration may be accessed in the group where the iteration number is 3. The files for the most previous iteration are the group with the iteration number 2 and the first iteration files are the group with iteration number 1. Note that this information is selection from the classification table as illustrated in Table 1 and may be implemented using a relational database query on Table 1.

In the travel expense approval workflow example in the introduction, the manager executes a conditional branch step to approve or reject the travel expense request. FIG. 9B illustrates a screen associated with a conditional branch step where the user downloads a file, uses the file as input to a program to determine the approval or rejection of the file, and uses either the “APPROVE” or “REJECT” button to convey the decision to the workflow system.

The present invention provides a system that applies workflow capability to business processes that use files as the form of the information units. The business process is divided into a sequence of process steps where files are attached or files are downloaded and each process step is related to a step in a workflow route. A tailored, classified file attachment screen is associated with each step in which files are attached. The screen is tailored to present entry windows, browse windows, for each file requested for that step. Each file is classified so that the file may be referenced using the meta-name, the classification, in subsequent steps or accesses to the file system. A tailored classified download screen is associated with each step in which files are downloaded. The screen is tailored to present file download links for each file to be downloaded for that step. The files are selected based on their classification. The tailored information is provided by the route step. The sequence of workflow steps with associated screen support the execution of the related business process. The tailored, classified attachment screen transfers the attached files to a file server with a classification database where the files are stored during the execution of the process. The tailored, classified download screen selects files from the file server based on the file classification and presents these for download by the user. The file server accesses the files using the file classifications for use subsequent processes or historical reference. The tailored, classified attachment screen and tailored, classified download screen associated with steps in a route and a file server with classification database provide a workflow system with the functions to support business processes that use files as the units of information.

A user of the file based workflow system may be a program or system. The screen interface provides the input and output interface to the file based workflow system and the effect of a human user at a screen can be duplicated by a program or system to use the file based workflow system. Thus, a portion or all of the function described as user operation may be performed by appropriately designed and developed programs or systems. The workflow system may be used to invoke and control the execution of these programs and systems.

### DESCRIPTION OF A PREFERRED EMBODIMENT

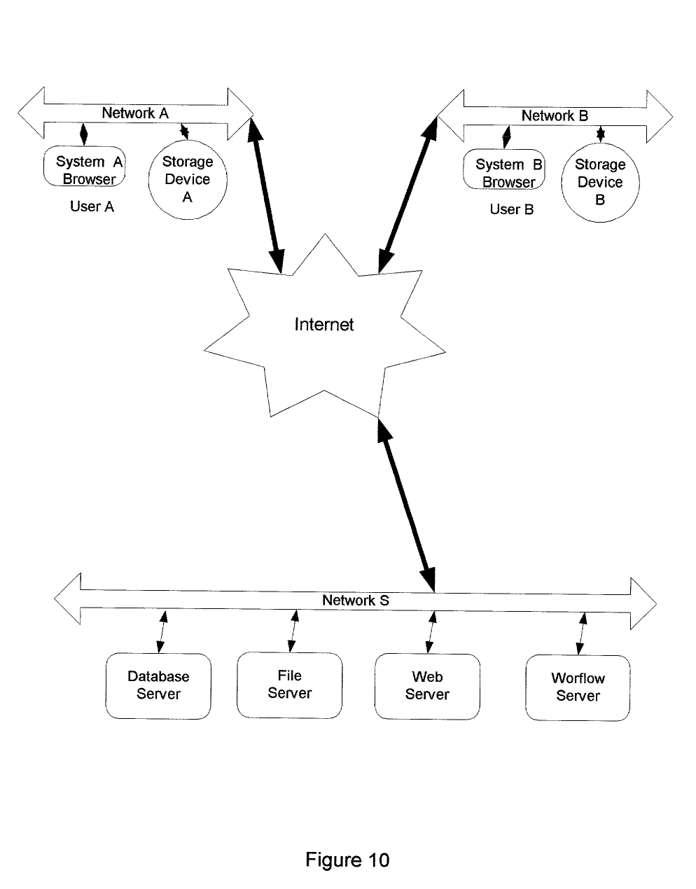

FIG. 10 illustrates an embodiment of a file based workflow system where the screens are implemented as Web pages and the networks are connected to the Internet. The file based workflow system is implemented using a database server, a file server, a Web server, and a workflow server connected to a network S. The servers are implemented as programs executing in computers. Database programs are available from Oracle, IBM, Microsoft, and many other providers. The file system programs are available from Microsoft or a number of Unix file systems. The Web server programs are available from Microsoft, Netscape, and others. The workflow server programs are available from BEA Systems, Extricity, and other providers. The workflow system is adapted to provide the additional functions of the file based workflow system. The adaptation is implemented as a software program written in Java, C++, Microsoft Visual Basic, or a number of programming languages. These programs and databases execute in computers manufactured by, for example, IBM, Sun, Dell, and Compaq. The computers may be, for example, PC's, workstations, mainframes, and hand-held computers. The computers may have an operating system such as UNIX, LINUX, Microsoft 2000, and IBM OS/9000. The computer is connected to a network that may be, for example, a LAN, WAN, Internet, Intranet, wireless LAN, or wireless Internet.

The workflow server adaptation directs the Web server to generate the tailored, classified attachment and download web pages using configuration information associated with each workflow step. The adaptation also generates the database transactions to classify files when the file is attached and extract the file names for accessing the files in the file system. The database is organized as described in Table 1. The adaptation further stores files and accesses files in the file system based on the file names in the classification database.

The workflow system provides tools for step development and route creation, manages the routes, manages the execution of active instances, records the history, provides a “To do” list for each user, etc. Ouchi describes a workflow system in U.S. Pat. No. 5,978,836; 6,170,002; 6,279,042 and these functions are the base functions for a workflow implementation. The workflow executes an instance of a route with a step associated with a tailored, classification attachment screen. The adaptation accesses configuration information associated with the step and directs the Web server to create a Web page with the information and browse windows to request the files as directed by the route step. The workflow system directs the Web server to make the Web page accessible by the user associated with the step. In the example, User A is given access to the Web page. User A has a computer with a Web browser connected to Network A that is connected to the Internet. User A uses the file browse function in the Web screen to locate the file fitting the classification information stored on storage device A and attaches the file. The classification information is also sent with the file. The file moves from storage device A through Network A to User A's computer with the Web browser to the Internet to Network S to the Web server. (There are a lot of firewalls, routers, and stuff to make this work but will not be described.) The adaptation program accepts the file and creates an entry in the classification database with the information described in Table 1 and stores the file in the file server using the file name in the classification database. This completes the tailored, classified file attachment screen functions for the step. In the example, the workflow advances to the next step that is associated with a tailored, classified file download screen for User B. The adaptation program accesses the classification database and obtains the file name and given name for the file that fits the classification in the step. The adaptation program directs the Web server to generate the tailored, classified file download screen as a Web page with a file download link displaying the given name and linked to the file name in the file server. The workflow system directs the Web server to make the Web page accessible to User B, the user associated with the step. User B has a computer with a Web browser program connected to Network B that is connected to the Internet. User B accesses the Web page and downloads the file by browsing Network B and locating a file directory in file system on storage device B and saving the file with a given name in the file directory. The file moves from the file server on Network S, to the Internet, to Network B and to storage device B. User B may access the file for processing in a system accessible to User B. Those skilled in the art recognize that these functions may be implemented in many ways using Web technology, client-server technology, or other technologies that provide the functions to configure screens, attach files, and download files.

I claim:

1. A tailored, classified file attachment screen provided to a user by a server connected to a network wherein the tailored, classified file attachment screen is associated with a step in a workflow route such that the classification of the file to be attached and the configuration of the file attachment means for the tailored, classified file attachment screen are provided by the workflow step and, using the file attachment means, the user can attach a file that is then sent with the classification information to the server.

2. The tailored, classified file attachment screen of claim 1 wherein the screen is a Web page and the server is a Web server.

3. The tailored, classified file attachment screen of claim 1 wherein the file attachment means can attach files with a parent-child relationship.

4. The tailored, classified file attachment screen claim 1 wherein the file classification includes a meta-name and an iteration indicator.

5. A tailored, classified file download screen provided to a user by a server connected to a network wherein the tailored, classified file download screen is associated with a step in a workflow route such that the classification of the file to be downloaded and the configuration of the file download means for the tailored, classified file download screen are provided by the workflow step, enabling the user to download the file from the server.

6. The tailored, classified file download screen of claim 5 wherein the screen is a Web page and the server is a Web server.

7. The tailored, classified file download screen of claim 5 wherein the download means can download files with a parent-child relationship.

8. The tailored, classified file download screen of claim 5 wherein the user can use the file classification to select files for downloading.

9. The tailored, classified file download screen of claim 5 associated with a workflow route step with a conditional branch wherein the user can indicate the branch choice and send the choice to the server.

10. A file based workflow system connected to a network wherein the file based workflow system contains a classification table and a route, a sequence of steps, and for a step requiring a file attachment, the step is associated with a tailored, classified file attachment screen and for a step requiring a file download, the step is associated with a tailored, classified file download screen.

11. The file based workflow system of claim 10 wherein the file classification is related to a file sever name using the classification table.

12. The file based workflow system of claim 10 and a file server wherein an attached file from a user of a tailored, classified file attachment screen is received; assigned a file name; the file name, the file given name and classification information are entered into the classification table; and the file is stored in the file server using the file name.

13. The file based workflow system of claim 10 and a file server wherein a file to be downloaded by a user of a tailored, classified file download screen is retrieved by using the file classification information from the associated step and the classification table to derive the file name and the file name is used to retrieve the file from the file sever so that it may be sent to the user when requested for downloading using the tailored, classified file download screen.

14. The file based workflow system of claim 10 wherein the classification table represents the parent-child relationship of a file to another file.

15. The file based workflow system of claim 10 wherein a step in the route with a conditional branch is associated with a tailored, classified file download screen and the user indicated choice is received and the choice is applied to the step with a conditional branch.

16. The file based workflow system of claim 10 wherein the iteration field in the classification table is used to relate the files used in an iteration of a route with an iterative loop and to distinguish these files from files used in other iterations.

17. The file based workflow system of claim 10 wherein the iteration field in the classification table is used to relate a file generated by a process with the input files used by the process.

18. The file based workflow system of claim 10 wherein the iteration field in the classification table is used to relate the files used in an instance of a route and to distinguish these files from files used in other instances of the route.

19. The file based workflow system of claim 10 wherein the route forks into two parallel sub-routes consisting of a first sub-route with a step to download a first file and a second sub-route with a step to download a second file.

20. The file based workflow system of claim 10 wherein the meta-name field in the classification table is used to relate the files with similar functional content for selection for downloading from the file server.
